(19) United States
(12) Patent Application Publication
(10) Pub. No.: US 2009/0276713 A1
(43) Pub. Date: Nov. 5, 2009

(54) NETWORK ACCESSIBLE CONTENT MANAGEMENT METHODS, SYSTEMS AND APPARATUSES

(76) Inventor: Michael P. Eddy, Del Mar, CA (US)

Correspondence Address: LAW OFFICE OF MICHAEL P. EDDY;MICHAEL P. EDDY, 12526 HIGH BLUFF DRIVE, STE. 300, SAN DIEGO, CA, 92130, US

(21) Appl. No.: 12/434,615

(22) Filed: May 1, 2009

Related U.S. Application Data
(60) Provisional application No. 61/049,618, filed on May 1, 2008.

(51) Int. Cl. G06F 3/01; G06F 15/16; G06F 17/30; G06Q 30/00

(52) U.S. Cl. 715/733; 709/206; 707/100; 705/14.72; 705/26; 707/E17.045

(57) ABSTRACT

A computer implemented method and system for transforming multiple data sources into information displayed on multiple websites and stored in a computer readable medium. One described method includes inputting two or more keywords in a computer readable medium, creating two or more data feeds based on said keywords or a combination of thereof from one or more data sources, displaying said data feeds in two or more modules located on one at least two websites; and updating said modules using said data feeds and input from users interacting with one or more of said websites.

### CROSS-REFERENCES TO OTHER RELATED PATENT APPLICATIONS

This application claims the benefit of U.S. provisional application Ser. No. 61/049,618, filed May 1, 2008 which is incorporated herein by reference in its entirety for all purposes.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND

### 1. Field

The claimed subject matter relates to systems, apparatuses and methods for distributing content information including website content and related information over a large number of web sites, web pages and other network accessible virtual destinations.

### SUMMARY

The illustrative embodiments provide a computer implemented method, apparatus, system, and computer usable program code for creating and updating a plurality of clients via one or more networks. In one implementation, one or more dynamic web pages containing dynamically updated modules are created based on the one or more keywords and then updated based on the keywords as well as other information, for example information derived from user interaction with one or more servers.

Embodiments include a computer implemented method and system for transforming multiple data sources into information displayed on multiple websites and stored in a computer readable medium. One described method includes inputting two or more keywords in a computer readable medium, creating two or more data feeds based on said keywords or a combination of thereof from one or more data sources, displaying said data feeds in two or more modules located on one at least two websites; and updating said modules using said data feeds and input from users interacting with one or more of said websites.

### BRIEF DESCRIPTION OF THE DRAWINGS

The accompanying drawings, which are incorporated in and constitute a part of this specification, illustrate embodiments of the claimed subject matter, and, together with the description, further explain the claimed subject matter. In the drawings,

FIG. 1 is a schematic diagram illustrating a data processing arrangement that can be used with embodiments of the claimed subject matter;

FIG. 2 is a block diagram of a data processing system in which aspects of the illustrative embodiments may be implemented;

FIG. 3 is a block diagram illustrating a data flow during the creation of a new site using the input of a domain name and a set of keywords according to embodiments of the claimed subject matter;

FIG. 4 is a flowchart illustrating a process wherein a server sends a web page to a user interface browser 304 in accordance with an embodiment of the claimed subject matter

FIG. 5 is a flowchart illustrating a client requesting a domain name based web site in accordance with an embodiment of the claimed subject matter;

FIG. 6 illustrates an embodiment having several independent web sites with varying numbers and types of modules;

FIG. 7 illustrates two modules as used side by side in another embodiment; and

FIG. 8 illustrates another embodiment which includes the use of several content sources, modules and web sites.

### DETAILED DESCRIPTION OF THE EMBODIMENTS

With reference now to the various figures in which identical elements are numbered identically throughout, a description of various exemplary aspects of the inventive subject matter will now be provided.

In accordance with an exemplary implementation of the inventive subject matter, there is provided a method for distributing various types of information across a distributed platform located on a network. The user interfaces may consist of a group of websites, web pages, or any other user interfaces which allow receipt and/or interaction with the information over a network such as the internet, a wide area network, or the world wide web. Examples of information that may be displayed to the user include data from image, video and text messaging including instant messaging and via the internet and via other gateways such as mobile phone gateways.

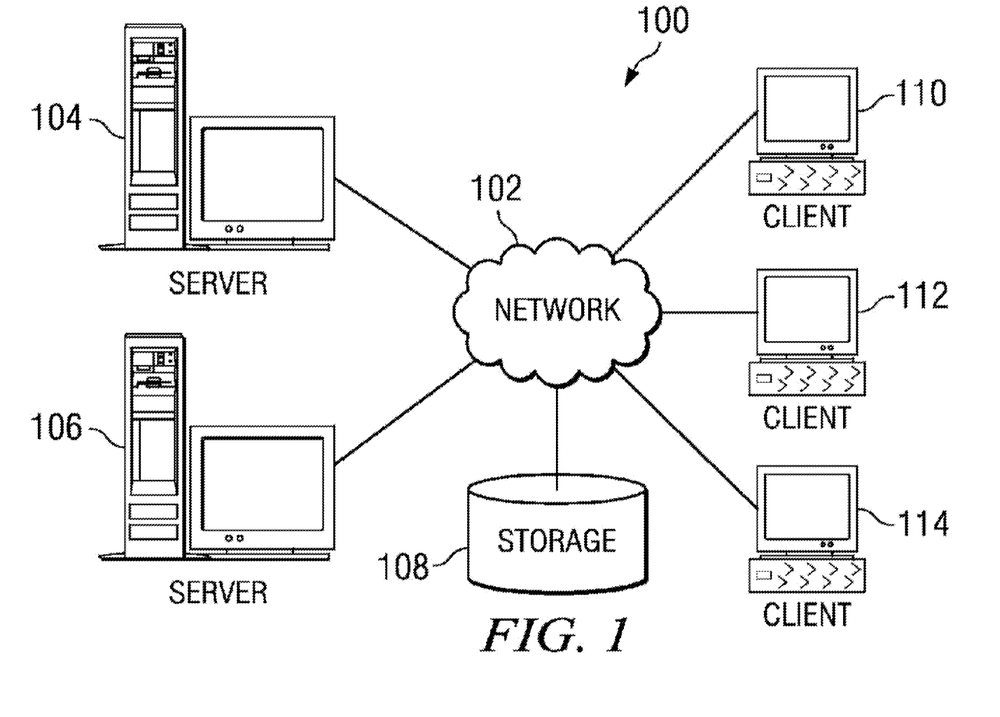

With reference now to the figures, FIG. 1 depicts a pictorial representation of a network of data processing systems in which aspects of the illustrative embodiments may be implemented. Network data processing system 100 is a network of computers in which embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In accordance with the aspects of the illustrative embodiments, server 104 and 106 are web service servers. In addition, clients 110, 112, and 114 connect to network 102. These clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In accordance with this illustrative example, clients 110, 112, and 114 transmit a web service request to a server, such as servers 104 and 106 via network 102. In response, web service server, such as servers 104 and 106, send a web service response to the client requester, such as clients 110, 112, and 114 via network 102.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for different embodiments.

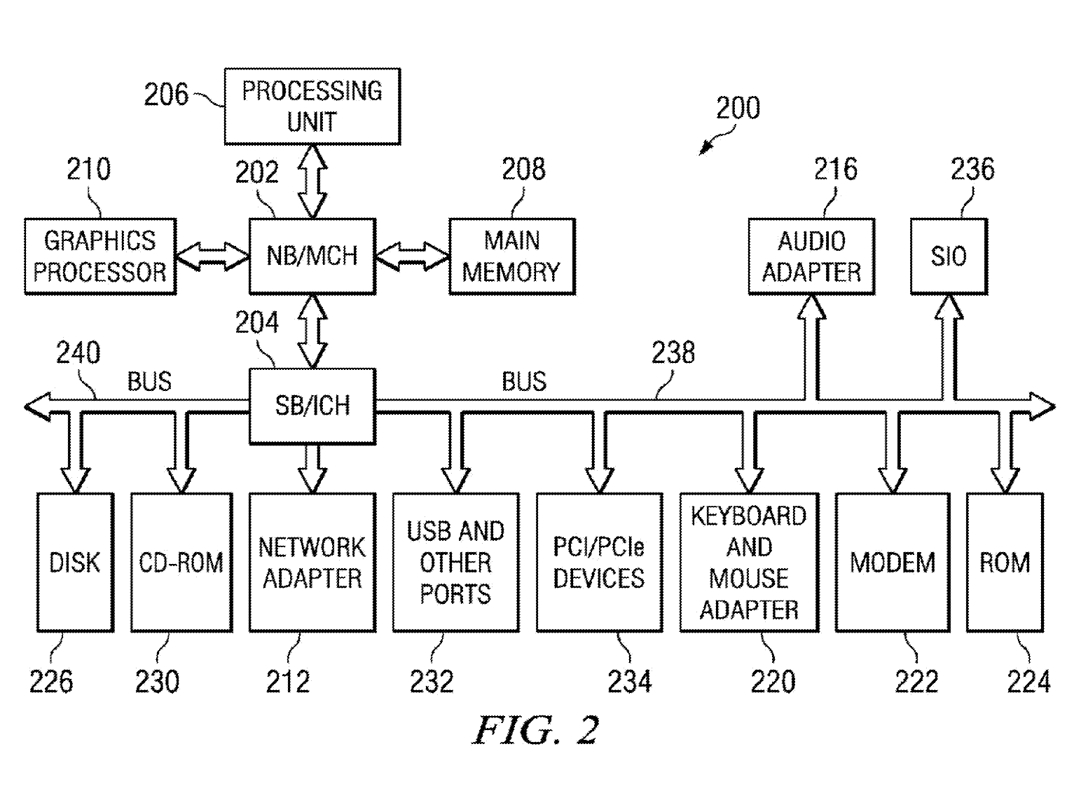

With reference now to FIG. 2, a block diagram of a data processing system is shown in which aspects of the illustrative embodiments may be implemented. Data processing system 200 is an example of a computer, such as server 104 or client 110 in FIG. 1, in which computer usable code or instructions implementing the processes for the different embodiments may be located.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are connected to the NB/MCH 202 and one or more graphics processors 210 may be connected to the NB/MCH 202 through one or more accelerated graphics ports (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS).

Hard disk drive 226 and CD-ROM drive 230 connect to SB/ICH 204 through bus 240. Hard disk drive 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206 and coordinates and provides control of various components within data processing system 200 in FIG. 2. As a client, the operating system may be a commercially available operating system such as Microsoft® Vista® or Windows® XP (Microsoft, Vista and Windows are trademarks of Microsoft Corporation.) An object-oriented programming system, such as the Java® programming system, may run in conjunction with the operating system and provides calls to the operating system from Java® programs or applications executing on data processing system 200 (Java is a trademark of Sun Microsystems.) Flash, a trademark of Adobe, may also be used for components of the inventive subject matter, such as providing data and information via the network interface.

The data processing system 200 may be any commercially available single or multiple servers running server software. This also includes cloud computing systems such as the cloud servers provided by Amazon® and the data processing system 200 may be a symmetric multiprocessor (SMP) system including a plurality of processors in processing unit 206. Alternatively, a single processor system may be employed. The servers use one or more operating systems such as the LINUX® operating system, (LINUX is a trademark of Linus Torvalds.)

Instructions for the operating system, the object-oriented programming system, and applications or programs are located on storage devices, such as hard disc drive 226, and may be loaded into main memory 208 for execution by processing unit 206. The processes for embodiments are performed by processing unit 206 using computer usable program code, which may be located in a memory such as, for example, main memory 208, ROM 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course, the bus system may be implemented using any type of communication fabric or architecture that provides for a transfer of data between different components or devices attached to the fabric or architecture. A communication unit may include one or more devices used to transmit and receive data, such as modem 222 or network adapter 212 of FIG. 2. A memory may be, for example, main memory 208, ROM 224, or a cache such as found in NB/MCH 202 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

Currently, the most commonly employed method of transferring data over the Internet is to employ the World Wide Web environment, also called simply “the Web”. In the web environment, servers and clients, such as servers 104 and 106 and clients 110-114 in FIG. 1, effect data transaction using the Hypertext Transfer Protocol (HTTP), a known protocol for handling the transfer of various data files. Examples of these types of data files include text, still graphic images, audio, and motion video. The information in various data files is formatted for presentation to a user by a standard page description language, the Hypertext Markup Language (HTML) or Extensible Markup Language (XML).

Every computer on the Internet has a unique identifying number called an Internet Protocol (IP) address. Every computer on the Internet can be identified and contacted by using the IP address for the computer. For example, if a user wants to access content on a server web page, the user at a client can use the IP address for the server computer to connect to that server and access the server's content. However, it would be very difficult for human users to remember an IP address for every web site that a user wants to access. Therefore, humans use domain names. A domain name is a human-readable host name to stand in for an IP address identifying a particular machine on the Internet.

A domain name server (DNS) is an Internet service that translates domain names into IP addresses. When a user wants to access a web page on a server, the user's client such as a browser contacts a domain name server to request an IP address corresponding to a given domain name. The domain name server generally responds by providing the IP address for the domain name or providing an IP address for another domain name server that might know the correct IP address for the domain name.

A content server is a server providing content or services to the user's client. A content server includes, but is not limited to, a web server, an e-mail server, a file transfer protocol (FTP) server, and/or an application server. In order to access a content server, a client must have an IP address to access a network interface on the server. As used herein, a network interface is any hardware and/or software providing a point of interconnection or interface between a user or client terminal and another machine on a network, such as the Internet. In other words, a network interface is the hardware and/or software that is designed to allow one computer to communicate with another computer over a computer network. A network interface is also referred to as a network adapter, a network card, and/or a network interface card.

If a machine only has a single network interface and that network interface is unreachable, a user will be unable to access the machine. Therefore, content servers are often multi-homed to improve reliability and availability of the content and services provided by the content server.

A multi-homed server is a server that has multiple network interfaces, each with a different IP address associated with the interface. When a client wishes to access the content server using the content server's domain name, the client sends a lookup query to the domain name server. The domain name server then provides all the IP addresses for the content server to the client. The domain name server provides all the IP addresses for a given domain name that have been added to the domain name server.

Typically, the client uses the first IP address that is provided by the domain name server to access the content server. The client queries the IP address provided by the domain name server in order to reach a network destination such as a website.

Therefore, the illustrative embodiments provide a computer implemented method, apparatus, system, and computer usable program code for creating one or more network destinations such as web sites based on a domain name and at least one keyword.

Further, a content server or a group of content servers provides users with web sites and/or web pages or any other network destinations which each provide two or more modules configured to provide to the user various content from the content server and/or content from sources of data outside of the content server.

In several embodiments, a network destination can be a web site, a web page, a widget, a gadget, a smart home display, a mobile phone, an appliance, a device in a vehicle, a television, a household or industrial item, or any other network accessible device.

In one embodiment, a domain name and one or more keywords are used to generate a web page based on the domain name's keyword content and the keywords used with the domain name. For example, the domain name livechat.com is parsed for the keywords live and chat. The domain name may also include one or more sub domain names such as livechat.landingsite.com. The second level extension may or may not be used in one or more modules. The domain name and keywords may be entered into the embodiments manually, via a control panel, a web page or site, a comma delimited format, via an SMS or text message, or via any other known means.

In several embodiments, the domain name can be assigned a temporary network destination address such as an IP address so that the compilation of the modules may be tested and the existing domain name may be redirected to this address for a period of time.

The keywords parsed from the content of the domain name can also be used for the automatic generation of a logo in a logo area of the web site, such as those found typically on the upper left hand side of web site pages. A TM may also be added to the logo to indicate common law usage of the mark in association with one or more of the content services or products which are offered via the modules.

In these embodiments, the web page generated contains several dynamically updatable modules each of which contain content than may be accessed by the user. One or more modules may also be editable, such as a forum module or a module which allows any third party user to edit the contents of the module such as a drawing program that is available to be viewed and edited by all users on that web site using that drawing module.

The keywords found in the domain name can be used to brand white label content or services offered through the module so that the domain name itself serves as a trademark. For example, using the domain name livechat.com with a live chat service module which provides live chat services between the site's owner and any of the web site's visitors and which can provide this live chat service to other web site owners at no charge or for a fee. A payment module may also be used to provide payment systems for third parties or for payments made to the site.

In several embodiments, once a new network destination is entering into the embodiment, for instance through the entry of a domain name and one or more keywords, a set of modules is provided initially to populate the network destination. The type and quantity of modules will depend on the character of the destination.

For example, a web site with a single home page can contain six to nine Adobe® Flash and/or Adobe® Air based modules each of which may or may not relate to the domain name and keyword topic. Upon initialization, these modules can also be pre-setup for specific topics and then rearranged by the administrator at a later time via a control panel accessible from the page or from another network accessible destination.

Cloud computing systems may be used to set up multiple network destinations with multiple DNS entries with each network destination receiving an allocation of modules based on the keywords and domain name. Any suitable platform and operating system may be used for the distribution of the network accessible destinations. For example, any suitable operating system such as LINUX or WINDOWS may be used for the one or more servers and Python® with Django® may be used to create, distribute and operate the individual modules at the various destinations. Upon creation of one or more network destinations, default profiles for both the type of network destination, for example a web site home page, and the keywords input along with the keywords parsed from the domain name. A database may also be used in conjunction with a default setting to provide a wide array of choices of defaults which may be selected initially by the user. In this way, a user could select from a palette of choices of modules and the user could similarly modify each module individually as needed.

Modules which may be included in a default setting include image, video, audio, and text modules. Once created, the network destination using the various modules may provide feedback to the embodiment so that content is added to the databases each time a module received data from user interactions. For example, a module containing a simple directory of links could add a user's query to a database of queries each time a search is performed by the user.

Module objects are initially controlled by the content server 306 and one or more additional servers, as needed. For example, an RSS feed aggregator script may aggregate news for a group of related topics and provide one or more feeds relating to that topic to a number of RSS feed modules displayed within one or more of the web site network destinations.

Other types of aggregators may be used to aggregate data from forum posts, blogs, articles, product offers, service offers, news updates, photos, videos, audio data, music, weather updates, real estate listings, Twitter updates, or any other type of information. Similarly, existing widgets and gadgets from third parties may be used for aggregation or to provide destinations for aggregators. In this way, content used for network destinations such as web sites can be dynamically updates on a regular basis with different destinations receiving different types and amounts of content as desired by the administrators and/or end users. Other types of network destinations such as intelligent home interfaces may also provide data and content back to the embodiment so that the information can be integrated into other systems and feeds within and external to the embodiments. For example, a smart home interface with cameras enables can send video and audio data back to the embodiment where it can be aggregated with other audio and video data and retransmitted to other network destinations.

In this way, a module for home security can be used so a group of users can monitor a large number of security audio and video feeds. A payment module with monitoring functions may also be used to pay third parties to perform the monitoring service and the home security module may be activated or deactivated as needed, for instance via SMS message by the user desiring the service. In other implementations, users will be able to choose modules which suit their destination's needs. For example, a photo module may be used to display a photographer's Flickr® feed of photos on a website used as a network destination. Additionally, the modules may be sized and positioned by both end users and administrators on the network destination, as desired.

Other module objects display real time forum posts and interactive online chats posted from a forum and chat content provider, respectively. These objects may themselves be provided to the various sites in varying formats so that no single module output is the same as another. For example, one or more feeds, such as current live chat or conversations such as those used in Twitter can be delayed for each module so that the displayed feeds are offset by a preset or random number of seconds. The modules themselves may also be interchanged with other modules in a similar manner so that the modules appearing on the site change on a regular basis. The modules position on each site may be changed at preset times or at random times.

In other embodiments, bidding functionality for all or part of each network destination may be used. In one embodiment, third parties can place bids to purchase positions for modules sponsored by the bidders. These bids can be placed for rights for specific periods of time or for quantities of use such as for a specific amount of uses by end users, for instance in a forum post module 100 posts by end users in a sponsored forum on a particular topic that relates to a sponsor. In another embodiment, the bids can be made for the content of one or more modules with the winning bidder gaining rights to display or provide content in that module for a specific period of time. In another embodiment, bidders may place links within one or more modules on a pay per click, pay per conversion or on a pay per impression basis, they may bid on one module on any basis, or they may bid on the entire group of modules or the site.

As previously described, the various modules may be used in conjunction with any number of other module type objects such as feeds, widgets, gadgets and/or other embeddable objects. All of the aforementioned module type objects may be interactive with by the users 300 as well as the administrative user or users.

Examples of specialized modules or objects include smart home widgets, such as smart home power monitoring and allocation, security, and environmental control. For example, a club of users could monitor several hundred enabled smart homes and make remote adjustments of environmental conditions to provide efficient use of power and water. Similarly, fire and intruder alarms can be monitored and remotely responded to via the embodiments. Network destinations may also be password protected so that only restricted users such as family members or friends may login and view the sensitive or private information.

Other modules include blog modules which allow users and administrators such as network destination owners to provide text, images and video for use with the module objects. Another module which may be used include a time management module which may also include a “to do” list and daily messages and updates related to time and goal management. Another module includes a geo specific alert regarding local conditions, such as outbreaks of sickness at local schools. Other modules include news and article feeds based on one or more databases which can be supplemented with external content.

Yet another module is aggregation of forum posts based on topics that can be selected so that they relate to the keywords used for the network destination. Advertising modules may also be used to provide text, images and video related to the keywords. These ads may provide pay per click links, pay per impression ads, or pay per action links such as payment for completed sales. Other advertising includes advertising within other types of modules such as blog, image or video modules for similar fee arrangements. Other modules can be designed to allow third parties to bid to place the modules either as a white label product or as a third party branded product.

Other modules include search modules which may be used to provide search functionality to the network destination. Live or time delayed conversations, images, or video posts may also be included in one or more modules so that content related to the keywords is output to the modules. For example, real time chats on several websites relating to a specific topic may be aggregated and be provided to one module. A user may also be permitted to interact with the conversation on some or all of the other websites in order to take part in the conversation.

Another module provides a pay per action option so that site users can be rewarded with payments of money or other consideration for participating in one or more activities. Another module may provide real time monitoring and analytics of module activity including activity on the local network destination along with activity across all of the same modules on all other network destinations. A “guest book” module may be used to automatically record and display records relating to visits and tags of visitors.

Another module is a “Who is Online” module including information related to each visitor to the network destination. These visitors may interact with this module with chat and by other means such as by providing a tag for their own records. Geo tags may also be automatically applied to the visitors. Video, image and/or audio feeds may also be used and associates with each visitor. In this manner, visitors are visible to other visitors along with their related information such as where their IP is located. By using additional tags, visitors may add their own tags to their assigned name, for example a link to their own web site.

Another module includes a “Ring Again” module for central communication and storage of phone numbers, email addresses and other related information. This module may also allow a site visitor to contact an administrator without revealing the administrator's current contact email and/or phone number. This module may import and export all types of contact information so that it can be used with a single module across thousands or hundreds of thousands of network destinations, for instance websites, pages or appliance screens in a smart home. In one embodiment, a click of a virtual button on this module located on any network destination will initiate a call to the predetermined party via the most economical means or via preferred method based on the date and time of the initiation of the contact. Similarly, all unanswered contacts can be directed to one or more voice mail boxes. For callers initiating the contact, one or more default messages may be used to respond to the contacts instead of allowing the contacts to complete. These messages can be changed as needed by the site administrator via any known means such as email or SMS messages.

Other modules include modules providing embeddable documents such as WORD® documents, and PDF® files, and modules that provide sharing of all known types of files and content such as links. Other sharing modules include stock photography and video content sharing. Other modules may provide services such as recommendation services, promotional services, membership services, book publishing services, appraisal, credit and financial services, and monitoring services.

Other modules may allow interaction with end users across multiple modules of the same or different types. These include drawing modules, bidding modules including bidding in auctions, and link exchanges, rating systems, and link directories based on bids. The administrators can allow or disallow access to any individual user for one or all of the modules.

Product related modules may also be used to offer products such as books and music. These products may be offered with or without product ratings derived from product rating data. Auction feeds such as eBay® auction feeds may also be used to offer products via one or more modules. Customizable products may also be offered with modules such as products which require the end user to upload text or images so the content can be applied to the product before shipping out to the end user.

A reminder service module may also be used to provide a reminder service to end users. In one embodiment, a white label reminder service allows the domain name to be branded as a signal to the source of the reminder service. The reminder service can automatically provide reminders by phone, fax, email or sms for any predetermined date or range of dates.

Other modules include email modules so that users may receive email at the domain name used for the network destination. A file uploading and storage service may also be offered.

Another module include a geo specific service request module allowing real time requests for service provider bids to be posted related to the keyword topic. Features of this module may include real time updates of pending service requests from partners such as monitoring of current assignments, for example monitoring an appliance repair person on route to appointment may show that he or she is currently on appointment one of six and because you are designated appointment six of six, you can estimate enough free time to leave your house for an errand instead of waiting all day for the repair person.

Other product and service modules may include similar data from strategic partners offering their related or unrelated services and products. This can allow other companies or service providers to pay to place their modules on one or more network destinations. For example, an art dealer may provide a feed of art presented for purchase or for rent via one or more modules. A bidding portal may also be provided so these partners can bid on the placement of one or more modules similar to a pay per click or pay per impression system found on Google® Adwords or Adsense systems.

Another module may include live conferencing services including live tutoring services offered by third party individuals or organizations. Another module provides tracking of satellite tracking enabled devices for a subscription.

In many of the described modules, third party users may interact with modules by entering text or action information such as click to vote and text entries to leave comments. In several modules, users are able to upload images, audio files, video files or any other file.

Each of the modules may be controlled from an administrator interface which allows each administrator to manage all of his or her network destinations. For instance, an administrator user with one or more network destinations may view the active modules and change any module for another. The administrator may also reposition an existing module or change other features of modules including color or any other attribute. Other features available to administrators include real time monitoring of both network destinations and modules active within each network destination. A support desk may also be integrated to provide support for end users.

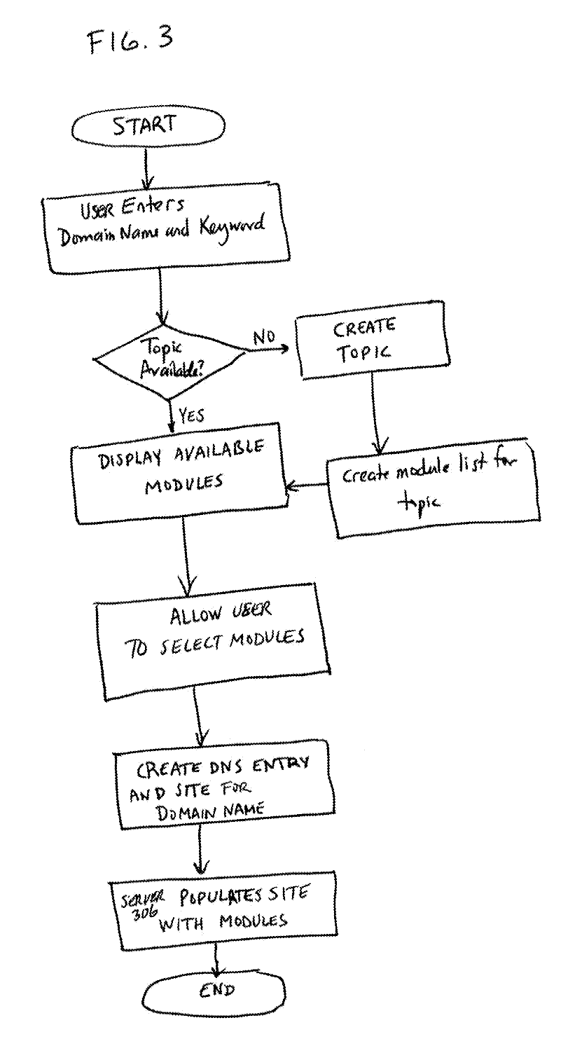

Turning now to FIG. 3, a block diagram illustrating a data flow during the creation of a new site using the input of a domain name and a set of keywords is depicted in accordance with an illustrative embodiment. In this embodiment six default modules are selected for inclusion into the network destination, a web site. The administrator of this web site can deselect each default module or select others to add to the site up to any number of modules. In other embodiments, the administrator may also save the selection of modules to his or her preferred list of selections so that the currently selected group of modules may be used again for other network destinations. For example, a clothing web site may include a “create dress” module for allowing users to create and select dresses for purchase from third party websites that make available custom dress creation services, a news module with news feeds using the clothing keyword, a blog module for populating the module with text entries related to clothing, an image module for allowing a slideshow of clothing related images, a product module for offering clothing, a forum module for displaying forum posts related to the topic of clothing, an advertising module showing pay per click links allowing the site owner to derive revenues from click through actions on ads by site end users, a live conversation module showing twitter feeds and other real time feeds related to clothing, a reminder service, a clothing related news feed, and an auction feeds showing current auctions for clothing related products.

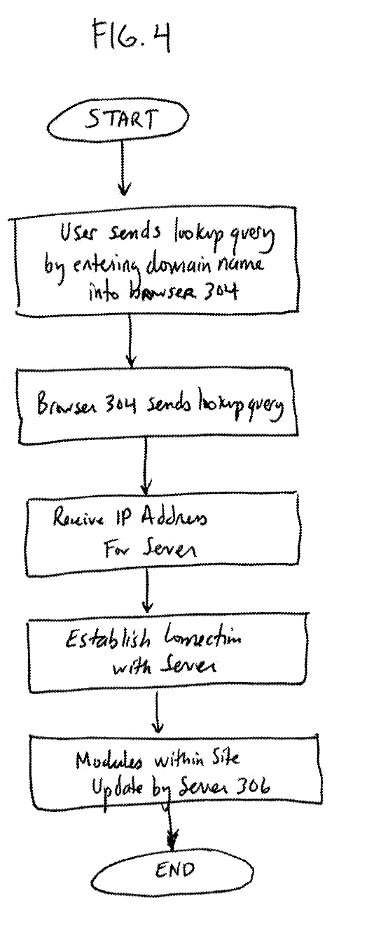

FIG. 4 is a flowchart illustrating a process for a server sending a web page to a user interface browser 304 in accordance with an illustrative embodiment. In the example illustrated in FIG. 4, the process is implemented by a server, such as server 104 or 106 in FIG. 1 or server 306 in FIG. 3.

When user 300 at client 302 wants to access content and/or services available on a content server, user 300 enters a domain name corresponding to the desired content server into browser 304 by means of user interface 306.

Client 302 is any known or available client computing device, including but not limited to, a desktop computer, a laptop computer, a personal digital assistant (PDA), a notebook computer, a cell phone, a smart device such as a personal pager, gps, watch or clothing item with embedded technology, and/or any other device to enable a user to access a network. In this illustrative example, client 302 is a client computer, such as clients 110-114 in FIG. 1.

Browser 304 can be any known or available software for enabling a client to access content and/or services on a network. For example, browser 304 can be implemented using browser software such as, for example, Microsoft® Explorer and Mozilla® Firefox.

User interface 306 may be implemented using any type of known or available interface for providing input to client 302, including but not limited to, a graphical user interface (GUI), a menu-driven interface, and/or a command line interface.

User 300 enters a domain name for a network site associated with server 306 wherein server 306 is any type of server, such as server 104 and 106 in FIG. 1. Server 306 can be a server on a network, such as network 102 described in FIG. 1. In one embodiment, server 306 is a multi-homed server having multiple network interfaces.

Client 302 accesses resources, such as web pages, files such as flash or Adobe® Air based files, and/or services on server 306 through a network connection via one of the network interfaces on server 306, such as network interface 308, 310, 312, and 314.

Network interfaces 308, 310, 312, and 314 are interfaces to allow or control access to another computer and/or another computer network. Network interfaces 308, 310, 312, and 314 include hardware and/or software that is designed to allow one computer to communicate with another computer over a computer network. In many embodiments, a network interface, such as network interfaces 308, 310, 312, and 314, may also referred to as a network adapter, a network card, and/or a network interface card. Server 306 provides content and/or services to Browser 304. In one implementation, user 300 connects to server 306 using an IP address for interface 314 and a web page located on a website is displayed on the browser 304.

In this example, a user 300 with browser 304 enters a domain name which corresponds to server 306 and browser 304 sends lookup query 328 to domain name server 322 to request an IP address for the domain name. The domain name server 322 sends IP address 330 to browser 304 and the IP address 330 corresponds to one of the network interfaces on server 306. Once a connection is created between the browser 304 and server 306 using one or more methods known to those skilled in the art, the server 306 then sends content and/or services from server to browser 304. The browser 304 can be periodically updated from server 306.

In this illustrative example, IP address 330 corresponds to interface 310. Client 302 uses IP address 330 to create connection 332 with server 306. Client 302 uses connection 332 to request content and/or services from server 306. Client 302 also uses connection 332 to receive content and/or services from server 306.

The user 300 receives content in the form a webpage delivered by server 306 which can be any type of server known to those skilled in the art that can provide content and/or services to the user 300, such as server 104 and 106 in FIG. 1. Server 306 can be a server on a network, such as network 102 described in FIG. 1 and it can be a multi-homed server having multiple network interfaces, including interfaces 338 and 340.

In this embodiment, the content is provided to a webpage on browser 304 and the content includes several flash based modules 410. Each of the modules 410 contains content which can be dynamically updated content and/or flash based content and services that can be viewed, heard, felt and/or accessed by the user 300. The user 300 may also interact with one or more of the modules 410. In one embodiment, the user interface includes a touch interface with each module providing tactile feedback to the user 300, for example Braille based information may be provided to each module so that the modules form several individual dynamically updated content delivery systems to the user. In other embodiments, the tactile feedback may be used along with other forms of content such as video, audio, and text.

In this example, domain name server 322 provides IP address 342 for server 306 and the client uses IP address 342 to establish a connection over a network with server 306. In response to the connection, server 306 sends content to browser 304 establishing an initial group of content that can be viewed and/or accessed by the user 300 via browser 304.

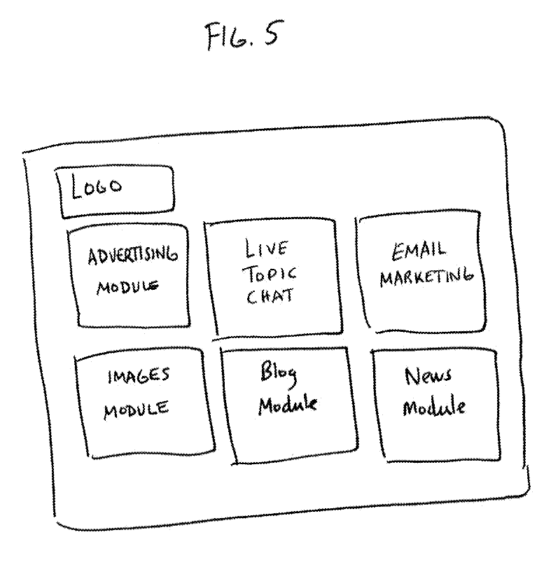

Turning now to FIG. 5, a flowchart illustrating a process for a client requesting a domain name based web site and page is depicted in accordance with an illustrative embodiment. FIG. 5 is a flowchart illustrating a process for establishing a new website and web page based on a domain name and several keywords provided by an administrator user in accordance with an illustrative embodiment.

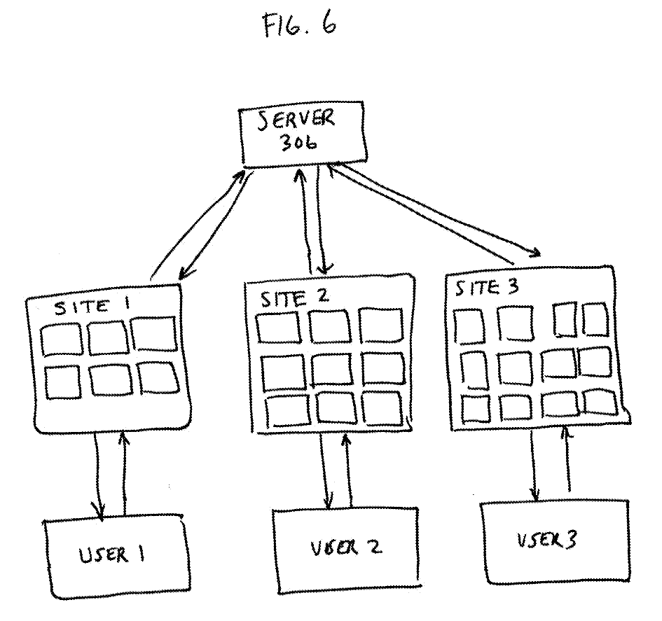

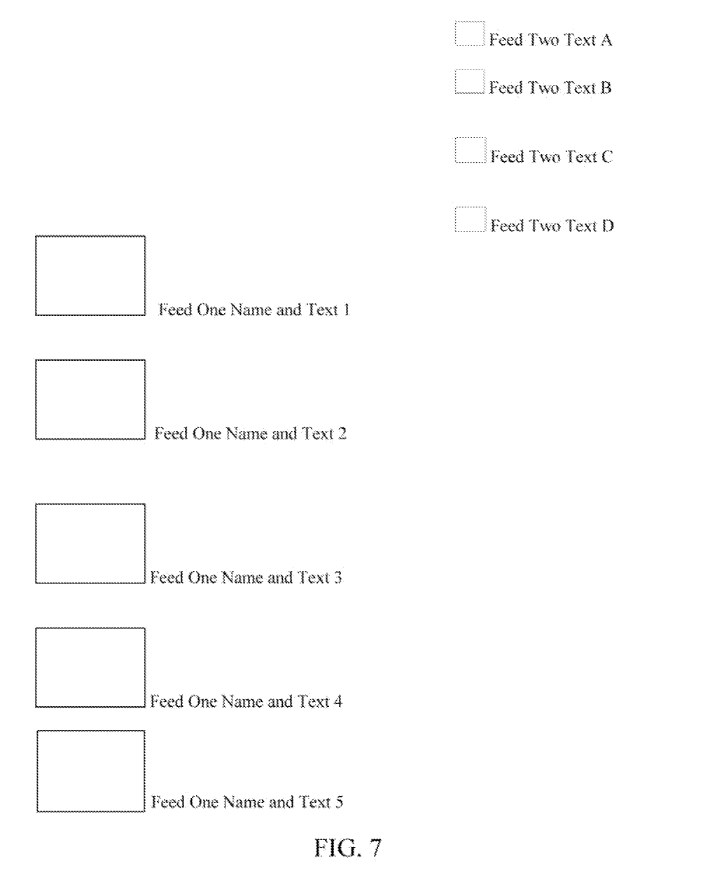

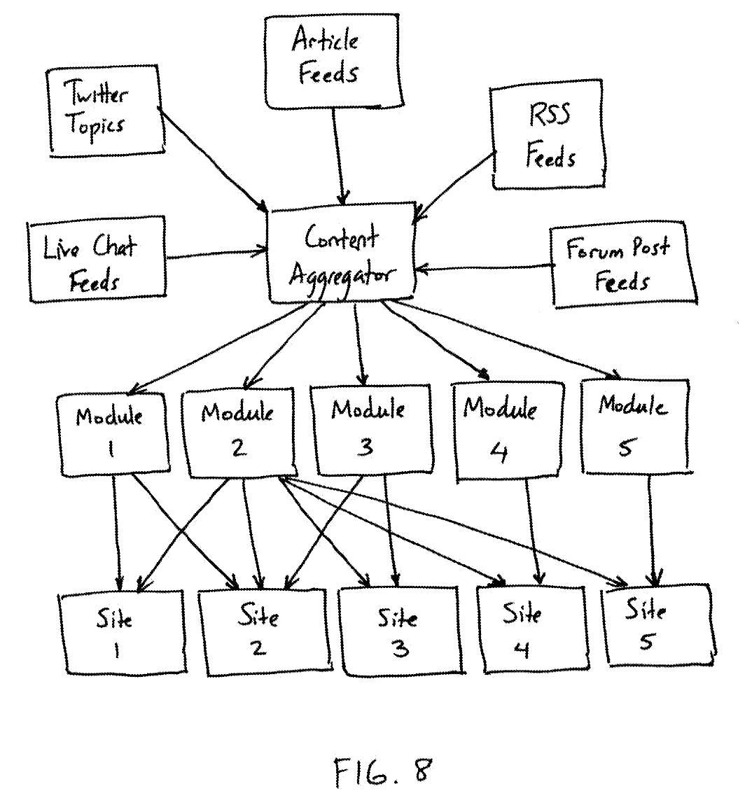

In this illustrative example in FIG. 5, a website is created for a specific domain name based on a domain name and one or more keywords entered by an administrative user. FIG. 5 illustrates an embodiment with a logo module and six additional modules placed on the web page. Each module may be updated independently of the other modules by server 306. FIGS. 6-8 show other embodiments of the inventive subject matter. FIG. 6 illustrates an embodiment with several independent web sites with varying numbers and types of modules. The modules are dynamically updated by server 306 and the users interacting with the websites may contribute content to the server 306 so it can be used on other network destinations including the other websites depicted. FIG. 7 illustrates two modules as used side by side in another embodiment. FIG. 8 illustrates the interaction of another embodiment including several content sources, modules and web sites.

Thus, the illustrative embodiments provide a computer implemented method, apparatus, and computer usable program product for creating a plurality of web sites based on groups of domain names and associated keywords. In addition to modules created for each website by default, additional modules may be added by an administrative user and external widgets or gadgets from third party websites may be added.

In other embodiments, modules may be used to create services provided under the brand of the domain name providing common law trademark rights in those domain names. White label services and content may be provided to the website allowing the branding of the domain name for those services or content products.

Embodiments can take the form of an entirely hardware embodiment, an entirely software embodiment or an embodiment containing both hardware and software elements. In several embodiments, the inventive subject matter is implemented in software, which includes but is not limited to firmware, resident software, embedded objects, microcode, or the like.

Furthermore, embodiments can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the various embodiments have been presented for purposes of illustration only and is not intended to be exhaustive or limited to the inventive subject matter in the form disclosed. Many modifications and variations will be apparent to those of ordinary skill in the art. The described embodiments were chosen and described in order to best explain the principles of the invention, the practical application, and to enable others of ordinary skill in the art to understand the invention for various embodiments with various modifications as are suited to the particular use contemplated.

No element, act, or instruction used in the present application should be construed as critical or essential to the invention unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise. Accordingly, it will be appreciated that changes may be made to the above described embodiments of the claimed subject matter without departing from the principles taught herein. Advantages of the claimed subject matter will become apparent for those skilled in the art after considering the principles in particular form as discussed and illustrated. Thus, it will be understood that the claimed subject matter is not limited to the particular embodiments described or illustrated, but is intended to cover all alterations or modifications which are within the scope of the appended claims.

What is claimed is:

1. A computer implemented method for transforming multiple data sources into information displayed on multiple websites stored in a computer readable medium, the method comprising the steps of:
inputting two or more keywords in a computer readable medium,
creating two or more data feeds based on said keywords or a combination of thereof from one or more data sources,
displaying said data feeds in two or more modules located on one at least two websites; and
updating said modules using said data feeds and input from users interacting with one or more of said websites.

2. The computer implemented method of claim 1 further comprising the steps of creating a logo image based on one or more of said keywords and displaying said logo image on one or more websites.

3. The computer implemented method of claim 2 wherein said logo image is created from one or more keywords derived from one or more domain names.

4. The computer implemented method of claim 1 wherein one or more of said modules is comprised of a reminder script to allow end users to input a reminder description, date and time so that they may be later notified of the reminder via any suitable electronic communication.

5. The computer implemented method of claim 3 further comprising a module providing a service to an end user in order to establish use of the logo in commerce sufficient to establish common law trademark rights in said logo.

6. The computer implemented method of claim 1 wherein said one or more modules displays advertising related to said one or more keywords.

7. The computer implemented method of claim 1 wherein said one or more modules is comprised of an online shopping cart for the offering and purchase of virtual or non virtual products or services via said one or more modules.

8. The computer implemented method of claim 1 wherein said one or more modules is comprised of an email service allowing end users to obtain and use email or other electronic communication addresses based on said domain name.

9. The computer implemented method of claim 1 wherein said one or more modules includes a file uploading, downloading and or backup service.

10. The computer implemented method of claim 1 wherein said one or more modules includes a calendar service.

11. The computer implemented method of claim 1 wherein said one or more modules may be controlled and/or modified from an administrator interface.

12. The computer implemented method of claim 11 wherein said modules are activated, deactivated, modify said visual or data attributes and/or repositioned on one or more of said websites.

13. The computer implemented method of claim 1, wherein said data is stored in at least one relational database which can be indexed and searched.

14. The computer implemented method of claim 1, wherein said at least two keywords and/or at least one domain name are input using data received within an electronic communication message selected from the following group: email, sms, rss, fax, SIP, voice to text and any combination thereof.

15. The computer implemented method of claim 14, further comprising the step of sending a confirmation message in response to a user's message, said confirmation message containing administrative access information in order to allow said end user make additions and modifications to said modules in said one or more websites, wherein said confirmation message is sent using an electronic communication message type selected from the following group: email, sms, rss, SIP, fax, voice to text and any combination thereof.

16. A computer implemented system for viewing and interacting with transformed multiple data sources stored in a computer readable medium and displayed on multiple websites, the computer implemented system comprising:
(a) a computational platform with a processor, memory and a storage medium;
(b) a viewer made up of a graphical user interface;
(c) a input device for allowing a user to input two or more keywords; and
(d) a feed aggregator for aggregating and creating two or more data feeds containing graphic and non graphic information derived from at least one data source based on said two or more keywords;
wherein the graphic and non graphic information contained in the data feeds are displayed on two or more websites with said viewer and wherein said viewer allow users with browsers to interact with said graphic and non graphic information.

17. The computer implemented system of claim 16 further comprising a receiver wherein the at least two keywords and/or at least one domain name are input using data received from an electronic communication message selected from the following group: email, SMS, RSS, FAX, SIP, voice to text and any combination thereof.

18. The computer implemented method of claim 17, further comprising a confirmation module for sending a confirmation message in response to a user's message, said confirmation message containing administrative access information in order to allow said end user make additions and modifications to said modules in said one or more websites, wherein said confirmation message is sent using an electronic communication message type selected from the following group: email, sms, rss, SIP, fax, voice to text and any combination thereof.
